(19) United States
(12) Patent Application Publication
(10) Pub. No.: US 2004/0229567 A1
(43) Pub. Date: Nov. 18, 2004

(54) Method and device for iterative JD equalization

(76) Inventors: Attila Bilgic, Kirchheim (DE); Thomas Ruprich, Munchen (DE)

Correspondence Address: Andreas Grubert, Baker Botts L.L.P., 910 Louisiana, One Shell Plaza, Houston, TX, 77002-4995, US

(21) Appl. No.: 10/818,303

(22) Filed: Apr. 5, 2004

Related U.S. Application Data
(63) Continuation of application No. PCT/DE02/02710, filed on Jul. 24, 2002.

(30) Foreign Application Priority Data
Oct. 5, 2001 (DE) DE 101 49 065.8

(51) Int. Cl. H04B 1/10; H04B 17/00

(52) U.S. Cl. 455/63.1; 455/67.11

(57) ABSTRACT

In a method for JD equalization of a received signal which is based on the superimposition of two or more spread-coded subscriber signals, a set of equalizer coefficients for the k-th subscriber is calculated in a first step by solving an inhomogeneous linear equation system whose coefficient matrix is based on the received signal. An iterative solution method is used in this case. In a second step, the received signal is equalized using the calculated equalizer coefficient set for the k-th subscriber.

### CROSS REFERENCE TO RELATED APPLICATION

This application is a continuation of copending International Application No. PCT/DE02/02710 filed Jul. 24, 2002 which designates the United States, and claims priority to German application no. 101 49 065.8 filed Oct. 5, 2001.

### TECHNICAL FIELD OF THE INVENTION

The present invention generally relates to a method for JD equalization of a received signal which has been transmitted via one channel and is based on the superimposition of two or more spread-coded subscriber signals, and to a JD receiver which operates on the basis of this method.

### DESCRIPTION OF THE RELATED ART

The UMTS (Universal Mobile Telecommunications System) Standard specifies the TDD (Time Division Duplex) mode for the so-called unpaired band (the frequency band which is provided for the uplink path and downlink path at the same time) for the third mobile radio generation. In contrast to the FDD (Frequency Division Duplex) mode, the maximum spreading factor for the TDD mode is equal to 16. Owing to this load spreading factor, individual subscriber detection as can be provided, for example, by means of matched filters (MF: Matched Filtering) is too inefficient. In order to make it possible to maintain a given quality of service (QoS), it is necessary to use high-performance JD (Joint Detection) algorithms.

In the case of JD algorithms (which are also referred to as multiple subscriber detection algorithms), the receiver takes account of signals from two or more active subscribers. The JD principle is for not only the desired subscriber signal but also the other subscriber signals to be accessed by explicit detection, such that they do not contribute to interference. This considerably reduces, or in the ideal case eliminates, the interference from other active subscribers.

One disadvantage of the already known JD algorithms is that they require a very high degree of computation complexity (owing to the multiple subscriber detection). Until now, the high degree of computation complexity has made it impossible to use JD algorithms in mobile stations, since it cannot be coped with by the signal processors which can be implemented in mobile stations at the moment.

One known method (although this involves far too much computation complexity for use in mobile stations) for solving the JD problem is described in Chapter B.4.2 on pages 315-318 of the book “Analyse und Entwurf digitaler Mobilfunksysteme” [Analysis and design of digital mobile radio systems] by P. Jung, B. G. Teubner Verlag Stuttgart, 1997. This solution approach is based on the Cholesky breakdown for a coefficient matrix which defines an inhomogeneous linear equation system. The matrix to be broken down is in this case a square matrix with the (large!) dimension (block size×number of subscribers).

An approximate Cholesky breakdown is proposed in the article “A Novel and Efficient Solution to Bock-Based Joint-Detection using Approximate Cholesky Factorization”, by H. R. Karimi et al., Ninth IEEE International Symposium on Personal, Indoor and Mobile Radio Communications, (Cat. No. 98TH8361), New York, Vol. 3, 1998, pages 1340-1345. The approximation is based on the assumption that the two matrices which are obtained from the Cholesky breakdown have a block Toeplitz structure. The Cholesky breakdown is carried out with less computation complexity on the basis of this assumption (which is only approximately correct). However, the coefficient matrix to be broken down also has the dimension (block size×number of subscribers) and is thus still difficult to handle. This method has the further disadvantage that the loss of accuracy caused by the approximation in the equalization process cannot be controlled or set. Thus, fundamentally, this method cannot guarantee any required quality of service. If, for example, an excessively high quality of service is achieved as a result of a favorable channel situation and/or a service with a low quality of service requirement (for example speech), this is generally of no practical use but if, for example, an excessively low quality of service occurs owing to a poor channel situation or a service with a high quality of service requirement, the method can no longer be used.

The article “Approximate and Incomplete Factorizations” by T. F. Chan et al., which can be obtained by downloading from http://citeseer.nj.nec.com/chan94approximate.html, describes various approximation approaches for solving a linear inhomogeneous equation system by means of so-called preconditioners. In this case, the coefficient matrix A of the linear inhomogeneous equation system Ax=b is replaced by another matrix M, which leaves the solution x to the equation system as unchanged as possible, but produces an equation system which can be solved more easily. This preconditioning of the linear equation system may be achieved, for example, by means of an ILU breakdown (Incomplete LU factorization) of the matrix A. The preconditioned linear equation system Mx=b can be solved by means of an iterative solution method, as described in the article.

The book “Templates for the Solution of Linear Systems: Building Blocks for Iterative Methods”, by R. Barrett et al., which can be obtained by downloading from http://citeseer.nj.nec.com/barrett93templates.html, describes a series of iterative solution methods, including CGS (Conjugate Gradient Squared Method) and Bi-CGSTAB (BiConjugate Gradient Stabilized Method) for solving a linear inhomogeneous equation system, as well as various preconditioning algorithms.

### SUMMARY OF THE INVENTION

The invention is based on the object of specifying a JD detection method which is suitable for use in mobile radio systems. In particular, the method should have a low degree of signal processing complexity which can also be matched as flexibly as possible to the specific situation (for example the required quality of service, characteristics of the radio channel). A further aim of the invention is to provide a JD receiver which has these characteristics for mobile radio systems.

The objective on which the invention is based can be achieved by a method for JD equalization of a received signal which has been transmitted via one channel and is based on the superimposition of two or more spread-coded subscriber signals, comprising the steps of:

calculating a set of equalizer coefficients for the k-th subscriber by solving an inhomogeneous linear equation system of the form m^{(k)}Ã=ζ, wherein

the coefficient matrix Ã being based on a reduced system matrix whose dimension is less than that of the system matrix, with the elements of the reduced system matrix being elements of the system matrix and only a selection or subset of the data symbols contained in a data block or burst being taken into account, and the coefficient matrix Ã being based on the received signal from the two or more subscribers,

the variable m^{(k)} describes a set of equalizer coefficients to be calculated for the k-th subscriber, and

the variable ζ describes the inhomogeneous part of the equation system; and

equalizing the received signal from the two or more subscribers using the calculated equalizer coefficient set m^{(k)} for the k-th subscriber; wherein

an iterative solution method being used for the solution of the inhomogeneous linear equation system.

The reduced system matrix which is based on the coefficient matrix of the linear equation system can be a reduced system matrix of dimension W×K(L+W−1), where W is a number which can be selected of chips which are taken into account in the equalization process, L is the channel length in chips, and K is the number of active subscribers. The iterative solution method can be a CGS method. The iterative solution method can also be a Bi-CGSTAB method. An initial equalizer coefficient set which can be used for the first iteration step is the zero vector. An initial equalizer coefficient set which is used for the first iteration step can be the vector which represents the inhomogeneous part of the linear equation system. An initial equalizer coefficient set which is used for the first iteration step can be the vector which is defined by the diagonal of the coefficient matrix of the linear equation system. A preconditioning algorithm can be used for determination of an initial equalizer coefficient set which is used for the first iteration step. The preconditioning algorithm can be an ILU breakdown. A preconditioning algorithm can be used, on the basis of which the initial equalizer coefficient set is determined taking into account an equalizer coefficient set which was calculated in a previous iteration. The method may further comprise the step of terminating the iteration when the convergence degree of the iteration is less than a first value. The method may further comprise the step of terminating the iteration when a measure for the interference power which is still present in the system becomes less than a second value. The method may further comprise the step of terminating the iteration when a measure for the achieved signal-to-interference ratio becomes greater than a third value. The method can be used for the equalization of signals in the TDD unpaired band of the UMTS Standard for mobile radio.

The object can also be achieved by a JD receiver for equalization of a received signal which is transmitted via one channel and is based on the superimposition of two or more spread-coded subscriber signals, comprising a first calculation means which is designed to calculate a set of equalizer coefficients for the k-th subscriber by solving an inhomogeneous linear equation system in the form m^{(k)}Ã=ζ, wherein

the coefficient matrix Ã being based on a reduced system matrix whose dimension is less than that of the system matrix, with the elements of the reduced system matrix being elements of the system matrix and only a selection or subset of the data symbols contained in a data block or burst being taken into account, and the coefficient matrix Ã being based on the received signal from the two or more subscribers,

the variable m^{(k)} describes a set of equalizer coefficients to be calculated for the k-th subscriber, and

the variable ζ describes the inhomogeneous part of the equation system; and

a second calculation means which equalizes the received signal from the two or more subscribers using the calculated equalizer coefficient set m^{(k)} for the k-th subscriber, wherein the first calculation means using an iterative solution method for the solution of the inhomogeneous linear equation system.

A system matrix which is based on the coefficient matrix of the linear equation system can be a reduced system matrix of the dimension W×K(L+W−1), where W is a number which can be selected of chips which are taken into account in the equalization process, L is the channel length in chips, and K is the number of active subscribers. The iterative solution method can be a CGS method. The iterative solution method can also a Bi-CGSTAB method.

JD equalization of the received signal, which is based on the superimposition of two or more spread-coded subscriber signals, is accordingly carried out with a set of equalizer coefficients for the k-th subscriber being calculated in first step by solving an inhomogeneous linear equation system whose coefficient matrix is based on the received (multiple subscriber) signal from the two or more subscribers. The received (multiple subscriber) signal is equalized in a second step using the calculated equalizer coefficient set for the k-th subscriber. In this case, an iterative solution method being used for the solution of the inhomogeneous linear equation system in the first step (that is to say for calculating of the equalizer coefficients).

One major advantage of the method according to the invention is that the two method steps mean that considerably less computation complexity is required to solve the JD problem than in the case of a conventional method, in which the complete system matrix is based on the linear equation system to be solved and the solution of this equation system provides all the equalized subscriber signals directly. In contrast to this, the method according to the invention does not make use of block equalization and, instead of this, the equalizer coefficients are first of all calculated as, so to speak, an intermediate step. These equalizer coefficients are already associated with the subscriber signal of interest. These equalizer coefficients are then used for specific equalization of the received signal (which is based on all the subscriber signals) with respect to this k-th subscriber.

The splitting of the equalizer process into two furthermore allows the coefficient matrix for the linear equation system to be solved in the first step to have a considerably smaller (and selectable) dimension than the coefficient matrix on which the linear equation system for conventional JD equalization is based.

A further major advantage of the method according to the invention is that the use of an iterative solution method for solving the inhomogeneous linear equation system allows the computation complexity in the first step to be matched to the given situation (for example the required quality of service, the channel characteristics at that time). Such “complexity matching” of the computation complexity is impossible when using direct solution approaches (which are referred to as direct solvers in the literature), such as the approximate Cholesky breakdown proposed in the article by H. R. Karimi cited initially.

In general, all the known iterative solution methods may be used for the method according to the invention, with the CGS method and the Bi-CGSTAB method appearing to be particularly suitable on the basis of the stability and computation complexity.

For iterative solution of an equation system, the convergence duration can be influenced by the choice of the initial equalizer coefficient set. In many cases, in particular when the channel conditions are not critical or the quality of service requirements are not stringent, the zero vector can simply be chosen as the initial equalizer coefficient set.

Further preferred options are to use either the vector which represents the inhomogeneous part of the linear equation system or the vector which is given by the diagonal of the coefficient matrix of the linear coefficient system as the initial equalizer coefficient set. All three options that have been mentioned offer the advantage of having no computation complexity, or only a very low degree of computation complexity.

It is also possible to use a preconditioning algorithm in order to determine an initial equalizer coefficient set which is used for the first iteration step. The preconditioned linear equation is thus in this case not the basis of the iteration, but is used just for the calculation of an initial value for the iteration.

A first preferred option is to provide an ILU breakdown as the preconditioning algorithm. This allows an initial equalizer coefficient set to be calculated which is already well matched to the sought equalizer coefficient set.

A further advantageous measure is to use a preconditioning algorithm on the basis of which the initial equalizer coefficient set is determined taking into account an equalizer coefficient set which was calculated in a previous iteration. This is based on the fact that the system matrix changes only gradually with time, so that previously calculated equalizer coefficients are still also approximately valid at a later time. A preconditioner which uses such previous calculation results likewise allows the iteration process to be speeded up considerably. The actual usefulness in this case depends on boundary conditions such as the speed, topographical characteristics (town/rural/mountains) etc. The simplest option is to use the equalizer coefficient set determined in the last iteration as the initial equalizer coefficient set.

As already mentioned, one major advantage of the solution according to the invention is that termination criteria can be set specifically for the iteration. A first advantageous option is for the iteration to be terminated when the convergence degree of the iteration becomes less than a predetermined first value. The convergence degree may be expressed as a relative error which is still present in the solution of the inhomogeneous linear equation system in the current iteration step.

An alternative criterion, which is likewise preferred, for termination of the iteration is to terminate the iteration when a measure for the multiple subscriber interference power remaining in the system becomes less than a predetermined second value.

It is also possible to assess the signal-to-interference ratio achieved in the course of the iteration and to terminate the iteration when a measure for the achieved signal-to-interference ratio becomes greater than a third predetermined value.

The first, second and third values may be variably matched to the specific situation (for example the channel conditions, the transmitted service) and, possibly, also to the hardware and/or software requirements in the receiver.

### BRIEF DESCRIPTION OF THE DRAWINGS

The invention will be explained in more detail in the following text using an exemplary embodiment and with reference to the drawing, in which:

FIG. 1 shows a schematic illustration of a JD receiver according to the prior art, in the form of a block diagram;

FIG. 2 shows a schematic illustration, showing the correspondence between the index k for the selected user and the index j of the zero forcing condition;

FIG. 3 shows a flowchart in order to explain the iterative solution of an inhomogeneous linear equation system;

FIG. 4 shows a schematic illustration in order to show an ILU preconditioning algorithm;

FIG. 5 shows a schematic illustration of a JD receiver according to the invention, in the form of a block diagram; and

FIG. 6 shows an illustration of the bit error rate plotted against the mean signal-to-interference ratio for various iterative and non-iterative solution approaches.

### DETAILED DESCRIPTION OF THE PREFERRED EMBODIMENTS

The mathematical description of the invention is based on the matrix vector formalism. A superscript letter T in the following text denotes the transposed matrix or the transposed vector, and the symbol * denotes the complex conjugate. A superscript letter H is an abbreviation for *T. An underscore under a mathematical variable means that it is or may be a complex value.

First of all, the following abbreviations are introduced:

K Number of active subscribers

N Number of data symbols in a block or burst

Q Spreading factor

L Channel length, that is to say the number of paths taken into account in the time-discrete channel model, in chips

W Number of chips taken into account for equalization

Ws Number of symbols taken into account for equalization, that is to say Ws=W/Q (possibly rounded up)

Ts Symbol time duration

Tc Chip time duration, where Q−Tc=Ts

| | |
|---|---|
| d^{(k)} = (d₁^{k} . . . d_{N}^{k})^{T} | Vector which represents the complex-value data |
| | symbols d₁^{k} . . . d_{N}^{k} transmitted by the k-th subscriber |
| | within one burst. The data symbols are transmitted at |
| | the symbol clock rate 1/Ts |
| c^{(k)} = (c₁^{k} . . . c_{Q}^{k})^{T} | Vector which represents the (subscriber-specific) CDMA code |
| | used by the k-th subscriber, in this case, c₁^{k} , . . . , c_{Q}^{k} are the |
| | complex chips of the CDMA code under consideration. The |
| | chips are transmitted at the chip clock rate 1/Tc |
| h^{(k)} = (h₁^{k} . . . h_{L}^{k})^{T} | Vector which represents the time-discrete channel impulse |
| | response applicable to the k-th subscriber; in this case, |
| | h₁^{k}, . . . , h_{L}^{k} are the complex weights (so-called channel |
| | coefficients) of the l-th, . . . , W-th transmission path, with |
| | adjacent transmission paths each having a time delay |
| | with respect to one another corresponding to the chip |
| | time duration Tc |
| b^{(k)} = (b₁^{k} . . . b_{Q+L-1}^{k})^{T} | Vector of the combined channel impulse response |
| | which is obtained using b^{(k)} = c^{(k)} * h^{(k)} from the |
| | CDMA code vector and the channel impulse vector for the |
| | k-th subscriber. In this case, * denotes the time-discrete |
| | convolution of the stated vectors |
| n = (n₁ . . . n_{NQ+L-1})^{T} | Vector of the additive interference; the vector n |
| | represents both thermal noise and multiple access |
| | interference, such as adjacent channel interference or |
| | intercell interference. The time discretization is based |
| | on the chip clock rate 1/Tc |
| e = (e₁ . . . e_{NQ+L-1})^{T} | Vector of the received data signal subject to interference; |
| | in this case, e = e₁ . . . e_{NQ+L-1} are the received chips |
| | received at the receiver at the chip clock rate 1/Tc |

The following description starts from the (multiple subscriber) system equation in the vector matrix description based on the time-discrete transmission model. This description of a transcription system is known in the prior art and is described in detail, for example, on pages 188-215 of the book “Analyse und Entwurf digitaler Mobilfunksysteme” [Analysis and design of digital mobile radio systems] by P. Jung, B. G. Teubner Verlag Stuttgart, 1997. This literature reference is included by reference in the subject matter of the present document.

In order to make the mathematical representation clearer, the following text considers a receiver with only one receiving antenna, with the further assumption that the signal is not scrambled at the transmitter end. Furthermore, for the sake of simplicity, it is assumed that each subscriber transmits only a single spread subscriber signal (single code user communication). The invention is not restricted to these assumptions. The system equation is:

e=Ad+n (1)

where the following notation is used:

$$\underline{d} = {( {\underline{d}}^{( 1 ) T} … {\underline{d}}^{( K ) T} )}^{T} = {( {\underline{d}}_{1}^{1} … {\underline{d}}_{N}^{1} , {\underline{d}}_{1}^{2} … {\underline{d}}_{N}^{2} , … , {\underline{d}}_{1}^{K} … {\underline{d}}_{N}^{K} )}^{T}$$

$$\begin{matrix}\underline{A} = ( {\underline{A}}_{μ , v} ) where & μ = 1 , … , NQ + L - 1 & ( number of lines ) \\ & v = 1 , … , KN & ( number of columns )\end{matrix}$$

The elements in the system matrix A are defined by the components of the vector b^{(k)} of the combined channel impulse response by the following relationship:

$${\underline{A}}_{Q ( n - 1 ) + l , N ( k - 1 ) + n} = \{ \begin{matrix}{\underline{b}}_{1}^{k} & for k = 1 , … , K \\ & l = 1 , … , Q + L - 1 \\ & n = 1 , … , N \\ 0 & else\end{matrix} \qquad ( 2 )$$

The vector e is thus the output of a transmission system which is described by the system matrix A, is supplied with the input vector d (based on all of the active subscribers), and also has an additive noise contribution described by the vector n.

The system which is described by the system matrix A comprises the channel and possibly also the structure of the receiver (for example the number of antennas (not considered here), oversampling). Based on the above terminology, the channel includes the physical channel as well as the transmitter-end signal processing (the block structure, spread codes and scrambling codes which are used, with the latter, as already mentioned, in this case being ignored for the sake of simplicity).

The system matrix A is known approximately in the receiver: this is because the physical channel is estimated by a channel estimator using conventional procedures and is described by its (estimated) channel coefficients (vectors h^{(k)}), assuming that the spreading codes and any scrambling codes that may possibly be used are already known.

The (system) input vector d is unknown in the receiver. The aim of data detection is to determine one or more estimated vectors \hat{d}^{(k)}=(\hat{d}ₗ^{k} . . . \hat{d}_{N}^{k})^{T} for one or more subscribers in the receiver, which vector or vectors matches or match the corresponding transmitted vector or vectors d^{(k)}=(dₗ^{k} . . . \hat{d}_{N}^{k})^{T} as closely as possible.

ML (maximum likelihood) and MAP (maximum a posteriori) criteria cannot be used because their computation complexity is too great to solve the JD problem (that is to say to solve the system equation (1)).

The JD problem is solved by describing the transmission system including the receiver by the linear equation system

\hat{d}=Se (3)

Analogously to the input vector d, the (system) estimation vector \hat{d} which relates to all the active subscribers is in this case formed by the following sequence of the estimated data symbols:

$$\underline{\hat{d}} = {( {\underline{\hat{d}}}^{( 1 ) T} … {\underline{\hat{d}}}^{( K ) T} )}^{T} = {( {\underline{\hat{d}}}_{1}^{1} … {\underline{\hat{d}}}_{N}^{1} , {\underline{\hat{d}}}_{1}^{2} … {\underline{\hat{d}}}_{N}^{2} , … , {\underline{\hat{d}}}_{1}^{K} … {\underline{\hat{d}}}_{N}^{K} )}^{T}$$

S is a (KN×NQ+L−1) matrix and determines the nature of the data detector. S is referred to in the following text as the estimation matrix.

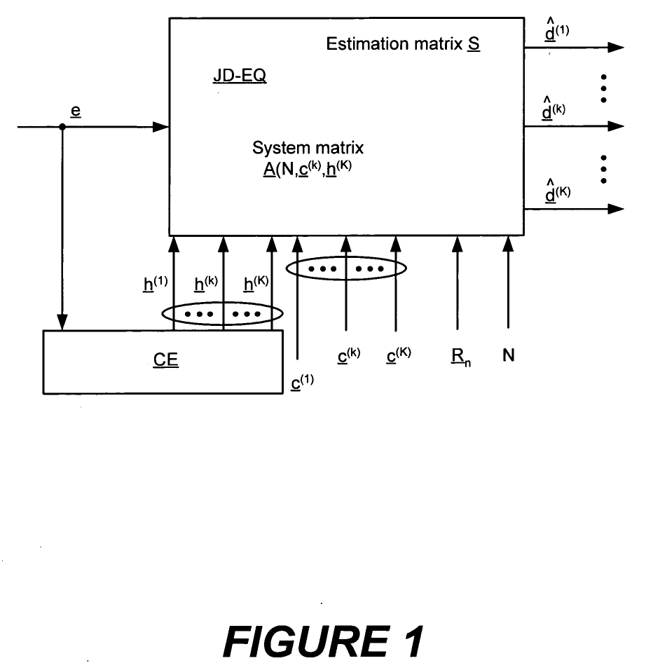

FIG. 1 shows the structure of a JD receiver as known per se. The JD receiver comprises a channel estimator CE and a JD equalizer JD-EQ. A already mentioned, the JD receiver receives the time-discretized vector e of the received signal, and passes this both to the channel estimator CE and to the JD equalizer JD-EQ. According to the prior art, the JD receiver estimates the vectors \tilde{d}^{(k)} for all the active subscribers k=1, . . . ,K. In order to determine these estimated vectors, the JD equalizer JD-EQ uses information relating to the channel, specifically the number N of data symbols per data block or burst, the spreading codes c^{(k)}, k=1, . . . ,K used by the active subscribers, as well as the channel impulse responses h^{(k)} determined by the channel estimator CE on the basis of the received signal. Furthermore, statistical information in the form of the covariance matrix Rₙ may be included in the data detection process. The covariance matrix Rₙ is defined by the expression Rₙ=E{nn^{H}}.

One known concept for solving the JD problem is ZF (Zero Forcing). ZF uses the following estimation matrix:

S=(A^{H}Rₙ⁻¹A)⁻¹A^{H}Rₙ⁻¹ (4)

In the simplest case, ignoring all interference, Rₙ=Id. Id denotes the identity matrix.

Substitution of the estimation matrix S according to equation (4) in equation (3) results in the following equation system:

A^{H}Rₙ⁻¹A\hat{d}=A^{H}Rₙ⁻¹e^{def}=g (5)

The normal way to solve this equation system (5) is based on the so-called Cholesky breakdown of the (KN×KN) matrix A^{H}Rₙ⁻¹A on the left-hand side of equation system (5). In a Cholesky breakdown, this matrix is broken down into a lower triangular matrix (that is to say a matrix in which all of the elements in the right-hand upper diagonal half of the matrix are equal to zero), and into a lower triangular matrix (that is to say a matrix in which all of the elements in the left-hand lower diagonal half of the matrix are equal to zero). The two triangular matrices are (KN×KN) matrices. Owing to the triangular form of these two matrices, the linear inhomogeneous equation system A^{H}Rₙ⁻¹A\hat{d}=g can then be solved by two recursions in opposite directions. This results directly in the (system) estimation vector \hat{d}, which relates to all of the subscribers, as the solution. A detailed description of the Cholesky breakdown is given on pages 315-318 of the initially cited book by P. Jung.

The procedure for the symbol-based equalization process according to the invention will be described in the following text. This is done in two steps.

1st Step:

A reduced system matrix Ã is first of all formed in the first step. The reduced system matrix Ã is a (W×K(L+W−1)) matrix, where W is the number of chips used for the equalization process and is referred to as the “equalizer length”. W is variable, subject to Q≦W<NQ. This means that only a selection or subset of the data symbols contained in a data block or burst are taken into account in this matrix. The reduced system matrix Ã is known approximately to the receiver by estimation of the channel coefficients (the vectors h^{(k)}) analogously to the system matrix A.

The reduced system matrix Ã is defined as follows:

$${\underline{\tilde{A}}}_{Q ( {w}_{s} - 1 ) + q , ( W + L - 1 ) k + {w}_{s} - 1} = \{ \begin{matrix}{\underline{b}}_{1}^{k} & for k = 1 , … , K \\ & l = 1 , … , Ws + L - 1 \\ & {w}_{s} = 1 , … , Ws \\ & q = 1 , … , Q \\ 0 & else\end{matrix} \qquad ( 6 )$$

(L+W−1) represents the influence length of a transmitted chip on the chip sequence of the received data signal. As already mentioned, Ws=W/Q denotes the equalizer length W in units of data symbols (Ws is rounded up if the quotient is not an integer). It should be mentioned that the block size N is not included in the definition of the reduced system matrix.

The system equation corresponding to equation (1) is:

\tilde{e}=Ã\tilde{d}+ñ (7)

where \tilde{e} and ñ correspond to the vectors e and n that are each W×1 (column) vectors with a number of lines corresponding to the equalizer length.

In order to simplify the description, the following text is based on the assumption of a noise-free channel, that is to say ñ=(0 . . . 0)^{T}. The invention is not restricted to this special case.

In the first step, the coefficients of an equalizer, in this case represented in the form of an equalizer vector m, are now calculated using the reduced system matrix Ã. The calculation of the equalizer coefficients is based on the ZF condition

mÃ=ζⱼ (8)

In this case, m is a 1×W (line) vector, which contains the equalizer coefficients, and ζⱼ is a 1×K(L+W−1) (line) vector which predetermines the ZF condition for a specific (k-th) subscriber.

The ZF vector ζⱼ can be represented as follows:

ζⱼ=(0 . . . 010 . . . 0) (9)

where the 1 is located at the j-th position of the vector. The j-th position is on the one hand associated directly with a data symbol to be detected and on the other hand selects, as will be explained in more detail in the following text, one specific user (referred to in the following text as the k-th user) from the two or more users.

The equation system (8) is solved by reorganizing it as follows:

mÃÃ^{H}=ζⱼÃ^{H}^{^{def}}=aⱼ^{h} (10)

The (line) vector aⱼ^{H} is defined by the dimension 1×W and by the expression ζⱼÃ^{H}.

In precisely the same way as the equation (5), the equation (10) represents an inhomogeneous linear equation system. The major differences between these two equation systems are:

that the coefficient matrix A^{H}Rₙ⁻¹A which occurs in the equation system (5) generally has a considerably larger dimension (specifically (KN×KN)) than the coefficient matrix ÃÃ^{H}, which occurs in the equation system (10) and whose dimension is (W×W); and

that the solution of the equation system (5) achieves the JD equalization object directly, while the solution of the equation system (10) initially produces only a “subscriber-related intermediate result” (that is to say the equalizer m for the k-th subscriber) for the JD problem.

The solution to the equation system (10) was described in a previous patent application DE 101 06 391.1 by the Cholesky breakdown of the (W×W) matrix ÃÃ^{H}. In contrast to this, the invention makes use of an iterative solution method which will be described in more detail later.

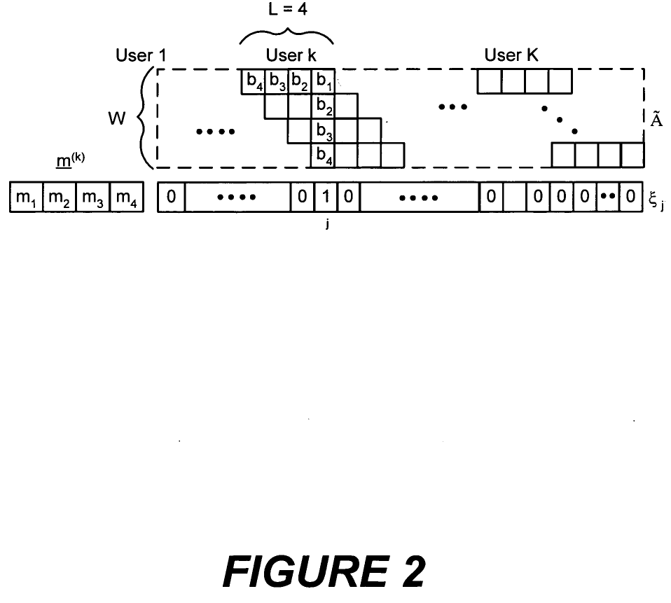

When solving the equation system (10), the ZF condition ζⱼ ensures that the equalizer vector is calculated for the k-th subscriber. In this case, j should be chosen such that aⱼ corresponds to the combined channel impulse response bₗ^{k} for the selected user k. The correspondence between k and the index j of the zero forcing condition is shown by the illustration in FIG. 2 for the example of W=4 and L=4.

The equation system (10) may, of course, also be solved for each of the K subscribers with the corresponding ZF condition, given by one of the ZF vectors ζⱼ according to equation (9). The equalizer vector calculated for the k-th subscriber is referred to in the following text as m^{(k)}.

2nd Step:

Once the equation system (10) has been solved, the received data stream is detected in a second step by means of the previously calculated equalizer vector m^{(k)} for the k-th subscriber, symbol-by-symbol. The second step is illustrated in the lower part of FIG. 2. The detection process is carried out by cross-correlation of the chips of the received data signal with the equalizer coefficients calculated for the k-th user using the equation

\hat{d}′^{(K)}=M^{(k)}e′ (11)

In this case, e′ is a Q(Ws+N−1)×1 column vector for the received chip sequence, \hat{d}′^{(K)} denotes the estimation vector for d^{(k)} calculated according to the invention, and the matrix M^{(k)} is a N×Q(Ws+N−1) matrix which is formed in the following manner from the equalizer vector m^{(k)}:

$$\begin{matrix}{\underline{M}}^{( k )} = \\ [ \begin{matrix}{m}_{W}^{k} & {m}_{W - 1}^{k} & ⋯ & {m}_{Q + 1}^{k} & {m}_{Q}^{k} & ⋯ & {m}_{1}^{k} & 0 & & ⋯ & & 0 \\ 0 & ⋯ & {m}_{W}^{k} & ⋯ & ⋯ & ⋯ & {m}_{Q + 1}^{k} & {m}_{Q}^{k} & ⋯ & {m}_{1}^{k} & ⋯ & 0 \\ ⋮ & & & & ⋰ & & & & & & & \\ ⋮ & & & & & ⋰ & & & & & & \\ 0 & & & ⋯ & & & & & & ⋯ & & {m}_{1}^{k}\end{matrix} ]\end{matrix} \qquad ( 12 )$$

This means that the elements of the equalizer vector M^{(k)} are entered in each line of the matrix m^{(k)} and are each arranged offset by Q digits with respect to one another, with respect to adjacent lines. The remaining elements in the matrix are zeros.

It follows from the equation (11) that only W complex multiplication operations are required for calculation of a data symbol from the equalizer vector m^{(k)}. This additional complexity in comparison to the solution of the equation system (5) based on the unreduced system matrix A is considerably less than the computation saving achieved by using the equation system (10), which is based on the reduced system matrix Ã.

The iterative solution of the equation system (10) in the first step will now be described in the following text. The following abbreviations are introduced in order to assist clarity:

Â=ÃÃ^{H}

z=aⱼ^{H}

The equation system (10) then becomes:

mÂ=z (13)

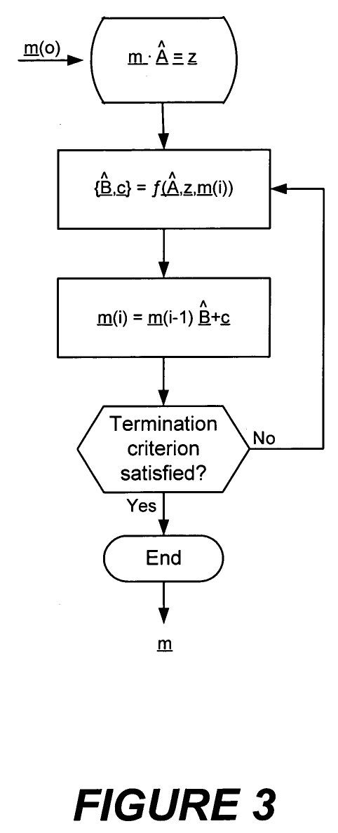

As is shown in FIG. 3, the iteration matrix \hat{B} and the iteration vector c are calculated by means of an initial equalizer m(0) from this equation system on the basis of a method-specific rule, which in this case is generally given by f(Â, z, m(i)). The dimensions of the matrices \hat{B} and Â as well as the vectors c and z are in each case identical, and the curly brackets in FIG. 3 indicate only a symbolic grouping of the two variables \hat{B} and c. The method-specific rule f(•) is governed by the linear iteration method that is used, or example CGS or Bi-CGSTAB.

In a next step, the iteration matrix \hat{B} and the iteration vector c are used in the equation

m(i)=m(i−1)\hat{B}+c (14)

to calculate a new equalizer m(i). In this case, i denotes the iteration index, which indicates the number of loops that have been passed through at any given time.

A termination criterion for the iteration process is then checked. If the termination criterion is satisfied, the iteration is terminated and the most recently calculated equalizer m(i) represents the solution of the inhomogeneous linear equation system (10). If the termination criterion is not satisfied, the iteration passes on to the next loop, i is incremented, and a new equalizer m(i) is calculated using the equation (14).

This results in a successive approximation to the solution, although this need not necessary be in a continuous form. Both the choice of the termination criterion and the choice of its dimension are application-dependent.

In addition to the CGS and Bi-CGSTAB iterative solution methods mentioned above, it is also possible, if required, to use further non-stationary iterative solution methods. CGS is described in Chapter 2.3.7 on pages 25 to 27, see in particular the program template in FIG. 2.9, and Bi-CGSTAB is described on pages 27 and 28, see in particular the program template in FIG. 2.10, of the book “Templates for the Solutions of Linear Systems: Building Blocks for Iterative Methods”, by R. Barrett et al., which can be downloaded from http://citeseer.nj.nec.com/barrett93templates.html. The content of this book and in particular the content of the stated text references are included by reference in the disclosure content of the application.

Various options for the termination criterion are mentioned in the following text.

A first option is to provide a termination criterion

$$\frac{‖ \underline{m} ( i ) \underline{\hat{A}} - \underline{z} ‖}{‖ \underline{z} ‖} \leq ϵ \qquad ( 15 )$$

This termination criterion measures the convergence degree achieved in the i-th iteration step and terminates the iteration process when this has a value of less than ε.

In addition to this standard termination criterion, it is also possible to use termination criteria which can be better matched to different applications. It should be remembered that the aim of the JD method is to deliberately eliminate interference caused by other subscribers. However, complete elimination of such interference is not practicable for a real receiver concept on the basis of cost-effectiveness aspects. The aim is in fact to ensure a certain required measure of interference suppression, for example by presetting a desired minimum signal-to-interference ratio or a maximum tolerable interference power level.

The following expression:

m(i)Ã=(ε₁, . . . εⱼ₋₁1+εⱼ₊₁ . . . ε_{K(L+W-1)}) (16)

which follows from the equations (8) and (9) is used for an equalizer which does not represent the exact solution in the equation system (10), such as that resulting from the equalizer m(i) as calculated in the i-th iteration step.

ε₁, . . . ,ε_{K(L+W-1)} are small in comparison to unity and tend to the value 0 as the solution accuracy of m(i) increases. In this case, εⱼ, where j′≠j represents a measure of the remaining interference of the respective j′-th interference component, and 1+εⱼ (which corresponds to the position j′=j) represents a measure for the detected signal power. This results in the two following pragmatic termination criteria:

The iteration process is terminated when the remaining interference power in the system becomes less than a value Eᵢₙₜₑᵣ:

∥m(i)Ã∥_{j′≠j}≦Eᵢₙₜₑᵣ (17)

The iteration is terminated when a measure for the achieved signal-to-interference ratio becomes greater than a value SIR_{target}:

$$\frac{{‖ \underline{m} ( i ) \underline{\tilde{A}} ‖}_{{j}^{′} = j}}{{‖ \underline{m} ( i ) \underline{\tilde{A}} ‖}_{{j}^{′} \neq j}} \geq {SIR}_{target} \qquad ( 18 )$$

In this case, Eᵢₙₜₑᵣ denotes the maximum permissible interference power, and SIR_{target} denotes the minimum permissible signal-to-interference ratio in the detected signal.

A further measure according to the invention is to choose a suitable initial equalizer m(0) for the equalization process. The five options proposed in the following text differ in the computation complexity that is required for determination of the initial equalizer m(0), and in the approximation to the exact solution that is achieved just by the initial equalizer m(0).

The iteration process is started using the zero vector, that is to say m(0)=0. This has the disadvantage that the convergence time is generally long, but has the advantage that the initial equalizer m(0) is obtained without additional computation complexity.

The iteration is started using m(0)=aⱼ^{H}, that is to say the right-hand side of the equation system (10). This approach generally provides a considerably better starting condition than m(0)=0. A further advantage is that practically no additional computation complexity is once again incurred for the production of the initial equalizer m(0).

Further options are based on the idea of starting the iteration process with an initial equalizer m(0) which is calculated by an algorithm with low complexity (as low as possible), and which produces an approximate solution for the sought equalizer m^{(k)} at this stage. In particular, preconditioners may be used to calculate these initial equalizers m(0).

The iteration is started with an initial equalizer m(0) whose elements are given by the diagonal of the reduced system matrix A. Once again, this has the advantage of low computation complexity for determination of m(0).

The iteration is started using an initial equalizer m(0) which is obtained by an ILU breakdown of the matrix ÃÃ^{H} and solution of the linear equation system which results from this. This has the advantage that the subsequent iteration process generally has a considerably shorter convergence time, but has the disadvantage of additional computation complexity which is incurred for the calculation of the initial equalizer m(0).

The iteration process is started at the time t using an initial equalizer mₜ(0) which is identical to the solution vector for the equalization vector m for the previous estimation time t−1, that is to say the equalization vector mₜ₋₁ calculated for the previous iteration: mₜ(0)=mₜ₋₁.

The ILU breakdown considers only a subset of the matrix elements of the matrix AA H to be broken down. In this case, there are various approaches and criteria for the selection of the subset, for example the structure of the matrix to be broken down or a tolerance limit for the values to be considered for the matrix to be broken down. The already mentioned article by F. Chan as well as the article “ILUT: A Dual Threshold Incomplete LU Factorization”, by Y. Saad, include a description of possible ILU approaches. The latter can be downloaded at the web address http://citeseer.nj.nec.com/saad94ilut.html.

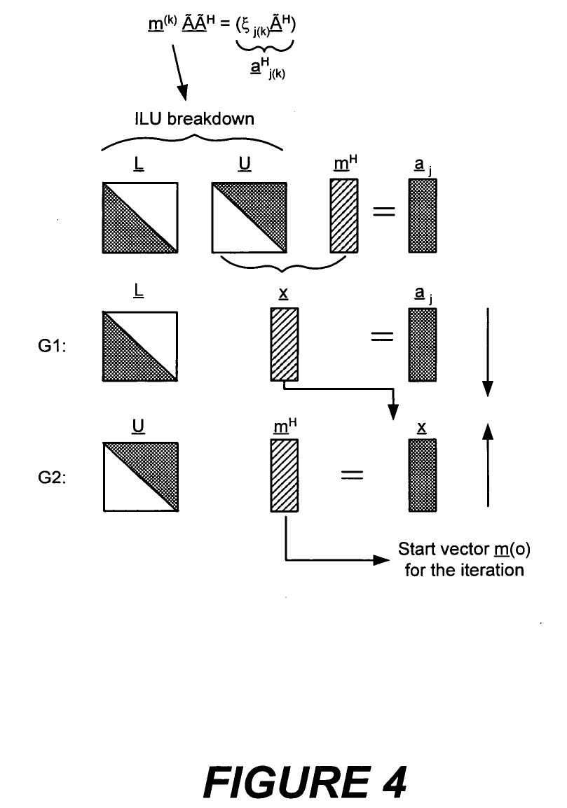

FIG. 4 shows an ILU breakdown based on the equation (10) which, for the k-th subscriber, is: m^{(k)}ÃÃ^{H}=ζⱼ₍ₖ₎Ã^{H}^{^{def}}=aⱼ₍ₖ₎^{H} and must be solved for one or more of the subscribers to be detected.

The breakdown of ÃÃ^{H} results in the lower triangular matrix L (for Lower) and the upper triangular matrix U (for Upper).

The two matrices L and U are W×W matrices. Known variables are shown on a dark background in FIG. 4, while unknown variables are shown by dashed lines.

The unknown vector x which is obtained from the matrix vector product of U and m^{H} can be determined by recursive solving of a trivial linear inhomogeneous equation system G1 with the coefficient matrix L, starting with the first component of x. This recursive solution to the equation system G1 is illustrated in FIG. 4 by an arrow pointing from top to bottom.

The components of the vector m H are determined recursively by means of the vector x, which is now known, from a second trivial equation system G2 with the coefficient matrix U, starting with the last component of m^{H}. The procedure for the recursive solution of the second trivial equation system G2 is indicated by an arrow pointing from bottom to top. Once the equation system G2 has been solved, the approximate solution is calculated for m^{H}. After transposition and conjugation, this is used as the start vector m(0) for the subsequent iteration process.

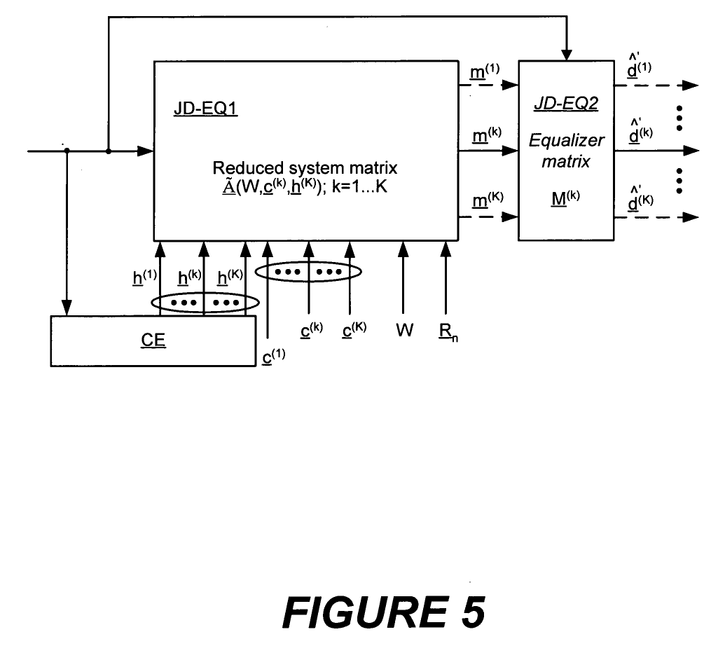

FIG. 5 shows a schematic illustration of the functional structure of a JD equalizer according to the invention. The same or comparable parts are provided with the same reference symbols as in FIG. 1.

A first computation unit JD-EQ1 is used to carry out the first method step, that is to say the iterative calculation of one or more equalizers m^{(k)} for one or more subscribers. The equalizer length W is preset here rather than the block length N.

The equalizer or equalizers m^{(k)} is or are supplied to a second computation unit JD-EQ2. This unit carries out the second method step, that is to say it uses the equalizer or equalizers m^{(k)} and the incoming received data symbols e (only the Q(Ws+N−1) data symbols of the vector e′ are required) to calculate the equalized data symbols \hat{d}′^{(k)}.

The two computation units JD-EQ1 and JD-EQ2 need not, of course, be in the form of individual computation units but may have any desired implementations with respect to their design and their hardware/software concept.

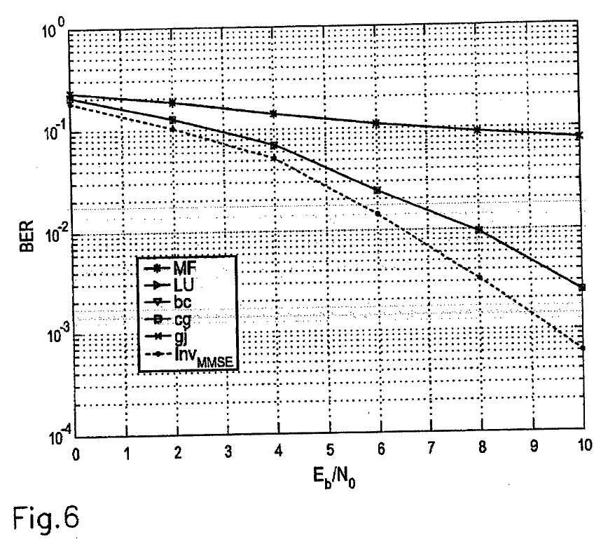

FIG. 6 shows a diagram in which the bit error rate (BER) is plotted on a logarithmic scale against the mean signal-to-interference ratio E_{b}N₀ (E_{b} denotes the mean energy which is associated with a single data bit at the receiver input, and N₀ denotes the spectral interference power density at the receiver input). The illustrated curves were determined for different receiver concepts. The curve MF denotes a matched filter concept and gives the poorest receiver behavior. The dotted curve Inv_{MMSE} indicates the receiver behavior for exact MMSE (Minimum Mean Square Error) detection by means of matrix inversion. The superimposed curves, which are obtained for a solution of the linear inhomogeneous equation system (10) by means of the Gauss-Jordan method (gj), complete LU factorization (LU) as well as the two iteration methods Bi-CGSTAB (bc) and CGS (cg) according to the invention are located in between. it is clearly evident that the iteration methods according to the invention can be used to achieve comparably good results to those achieved by means of the cited other methods.

We claim:

1. A method for JD equalization of a received signal which has been transmitted via one channel and is based on the superimposition of two or more spread-coded subscriber signals, comprising the steps of:
calculating a set of equalizer coefficients for the k-th subscriber by solving an inhomogeneous linear equation system of the form m^{(k)}Ã=ζ, wherein
the coefficient matrix Ã being based on a reduced system matrix whose dimension is less than that of the system matrix, with the elements of the reduced system matrix being elements of the system matrix and only a selection or subset of the data symbols contained in a data block or burst being taken into account, and the coefficient matrix Ã being based on the received signal from the two or more subscribers,
the variable m^{(k)} describes a set of equalizer coefficients to be calculated for the k-th subscriber, and
the variable ζ describes the inhomogeneous part of the equation system; and
equalizing the received signal from the two or more subscribers using the calculated equalizer coefficient set m^{(k)} for the k-th subscriber; wherein
an iterative solution method being used for the solution of the inhomogeneous linear equation system.

2. The method as claimed in claim 1, wherein the reduced system matrix which is based on the coefficient matrix of the linear equation system is a reduced system matrix of dimension W×K(L+W−1), where W is a number which can be selected of chips which are taken into account in the equalization process, L is the channel length in chips, and K is the number of active subscribers.

3. The method as claimed in claim 1, wherein the iterative solution method is a CGS method.

4. The method as claimed in claim 1, wherein the iterative solution method is a Bi-CGSTAB method.

5. The method as claimed in claim 1, wherein an initial equalizer coefficient set which is used for the first iteration step is the zero vector.

6. The method as claimed in claim 1, wherein an initial equalizer coefficient set which is used for the first iteration step is the vector which represents the inhomogeneous part of the linear equation system.

7. The method as claimed in claim 1, wherein an initial equalizer coefficient set which is used for the first iteration step is the vector which is defined by the diagonal of the coefficient matrix of the linear equation system.

8. The method as claimed in claim 1, wherein a preconditioning algorithm is used for determination of an initial equalizer coefficient set which is used for the first iteration step.

9. The method as claimed in claim 8, wherein the preconditioning algorithm is an ILU breakdown.

10. The method as claimed in claim 8, wherein a preconditioning algorithm is used, on the basis of which the initial equalizer coefficient set is determined taking into account an equalizer coefficient set which was calculated in a previous iteration.

11. The method as claimed in claim 1, comprising the following step:
terminating the iteration when the convergence degree of the iteration is less than a first value.

12. The method as claimed in claim 1, comprising the step:
terminating the iteration when a measure for the interference power which is still present in the system becomes less than a second value.

13. The method as claimed in claim 1, comprising the step:
terminating the iteration when a measure for the achieved signal-to-interference ratio becomes greater than a third value.

14. The method as claimed in claim 1, wherein the method is used for the equalization of signals in the TDD unpaired band of the UMTS Standard for mobile radio.

15. A JD receiver for equalization of a received signal which is transmitted via one channel and is based on the superimposition of two or more spread-coded subscriber signals, comprising
a first calculation means which is designed to calculate a set of equalizer coefficients for the k-th subscriber by solving an inhomogeneous linear equation system in the form m^{(k)}Ã=ζ, wherein
the coefficient matrix Ã being based on a reduced system matrix whose dimension is less than that of the system matrix, with the elements of the reduced system matrix being elements of the system matrix and only a selection or subset of the data symbols contained in a data block or burst being taken into account, and the coefficient matrix Ã being based on the received signal from the two or more subscribers,
the variable m(k) describes a set of equalizer coefficients to be calculated for the k-th subscriber, and
the variable ζ describes the inhomogeneous part of the equation system; and
a second calculation means which equalizes the received signal from the two or more subscribers using the calculated equalizer coefficient set m(k) for the k-th subscriber, wherein
the first calculation means using an iterative solution method for the solution of the inhomogeneous linear equation system.

16. The JD receiver as claimed in claim 15, wherein a system matrix which is based on the coefficient matrix of the linear equation system is a reduced system matrix of the dimension W×K(L+W−1), where W is a number which can be selected of chips which are taken into account in the equalization process, L is the channel length in chips, and K is the number of active subscribers.

17. The JD receiver as claimed in claim 15, wherein the iterative solution method is a CGS method.

18. The JD receiver as claimed in claim 15, wherein the iterative solution method is a Bi-CGSTAB method.
